(19) United States
(12) Patent Application Publication
(10) Pub. No.: US 2010/0206295 A1
(43) Pub. Date: Aug. 19, 2010

(54) SYSTEMS AND METHODS OF SOLAR THERMAL CONCENTRATION FOR 2-DIMENSIONAL FOCUSING CONCENTRATORS INCLUDING FEATURES OF SEQUENTIAL HEATING, THERMAL LOSS REDUCTION, AND/OR ADJUSTMENT OF OPERATION OR OPERATING PARAMETERS

(76) Inventors: Xiao Dong Xiang, Danville, CA (US); Rong Zhang, Cupertino, CA (US)

Correspondence Address: DLA PIPER LLP (US ), 2000 UNIVERSITY AVENUE, EAST PALO ALTO, CA, 94303-2248, US

(21) Appl. No.: 12/699,833

(22) Filed: Feb. 3, 2010

Related U.S. Application Data
(60) Provisional application No. 61/149,554, filed on Feb. 3, 2009.

(51) Int. Cl. F24J 2/38; F24J 2/00; G05B 19/02

(52) U.S. Cl. 126/601; 126/714; 700/275

(57) ABSTRACT

Systems and methods are disclosed including innovations related to aspects of solar concentration and/or the collection, transfer, or utilization of thermal energy. In some exemplary implementations, systems and methods of generating thermal energy using a plurality of solar modules are set forth, with each solar module includes a collector and a receiver.

### CROSS-REFERENCE TO RELATED PATENT APPLICATIONS

This application claims benefit/priority of U.S. provisional patent application No. 61/149,554, filed Feb. 3, 2009, entitled Configuration of 2-D Modular Solar Thermal Concentrator Array, which is incorporated herein by reference in its entirety.

### BACKGROUND

1. Field

Aspects of present innovations relate generally to solar concentration, and, more specifically to systems and methods consistent with solar concentration and/or the collection, transfer, or utilization of thermal energy, such as may be associated with array(s) of solar concentrators and/or heat transfer fluid(s).

2. Description of Related Information

There are two types of concentration solar thermal applications. In one type of such applications, solar (optical) energy is collected and focused on to a target, where a Stirling Engine is used to convert the thermal energy into mechanical energy directly to drive an electrical generator. In another type of such applications, solar (optical) energy is collected and converted to thermal energy by an optical collector, a receiver, and heat transfer fluid (HTF). This thermal energy is then converted to either electrical energy or used directly for other applications, such as cooling or heating. In such applications, optical collection efficiency and thermal loss determine the overall solar energy to thermal energy conversion efficiency.

The optical collection efficiency is determined by whether the concentration focus and tracking is two-dimensional, such as a parabolic dish where normally a better than 80% of optical collecting efficiency can be achieved, or one-dimensional, such as a parabolic trough where a peak optical collection efficiency of cos φ*64% can be obtained (where φ is the latitude angle at the trough solar field). The optical collection efficiency is determined by the reflection rate of the surface materials used (often a silver coated glass mirror), which is normally in the order of 85 to 96%, and the “cosine” angle for the reflection optics, where the cosine angle is defined by the direct incident solar array versus the normal direction of the reflection surfaces. With parabolic dish approach, this cosine angle loss is less than 5% and is independent to the latitude angle at the solar field location because the tracking mechanism always keeps the parabolic dish perpendicular to the solar array. With parabolic trough approach, this cosine angle relates to the latitude angle at the solar field location and the time of the year (season), i.e., the solar array versus the normal direction of the trough mirror. If the parabolic trough solar field has a latitude angle of 30 degree, the annual average cosine angle loss will be 25%. Hence, two-dimensional tracking parabolic dish approach has higher optical collection efficiency due to intrinsic smaller cosine angle loss comparing with one-dimensional tracking parabolic trough approach. However, parabolic dish approach requires two independent tracking mechanisms to follow the Sun movement during the day. To reduce the relative cost of the tracking system per unit collection area, a large area of dish should be used. On the other hand, the large collecting area inevitably increases the wind load of the collecting system, which requires a stronger mechanical structure to sustain a possible damage wind load. This introduces a dilemma circle: to increase the optical collection efficiency, one needs to take 2-dimensional focusing and tracking approach, to reduce the tracking cost, one needs to increase the optical collecting area, but that will cause large wind load to make the system too balky and expensive, which will cancel out the benefit of improved optical collecting efficiency.

The thermal loss of the solar receiver is determined by the sum of conducting loss, convection loss and black-body radiation loss, where the first two thermal loss is linearly proportional to the temperature difference between the solar collector and the ambient. The black-body radiation loss, however, is proportional to the 4^{th} power of the temperature difference. Obviously, at a relatively higher temperature, the black-body radiation loss will dominant the total thermal loss.

In order to increase the solar energy to thermal energy conversion efficiency, systems and methods may be utilized that increase the optical collecting efficiency while reducing the thermal loss as much as possible.

Another important aspect for reducing thermal loss is to design system configuration properly. A solar collector field can consist of thousands of individual modules. Each module has its own input and output for thermal energy transfer fluid. Each module has a fixed power generating capacity with a given solar incident energy level. There are different ways to interconnect them to form a larger power generating entity with a desired output fluid temperature and flow rate. In typical 1-D thermal concentrators, such as parabolic trough, multiple modules are aligned in a row and thermal fluid pipes are connected in series first, and then different rows are connected in parallel to increase the flow flux or rate. However, due to larger cosine angle and relative larger aperture to optical collector ratio for trough mirrors, both the convection loss and the black body radiation loss are significantly larger than those from parabolic dish solar modules.

For 2-D concentrators, such as parabolic dishes, most of the applications use a Stirling Engine at the focal point to convert the thermal energy directly into mechanical motion where electricity is generated. Only very few applications used a parallel connections to interconnect multiple modules, as shown in FIG. 1 with HTF. More specifically, FIG. 1 shows solar modules 11 each connected to an inlet pipe 12 and each connected to an outlet pipe 13 in a parallel manner. The regular 2-D concentrator modules are very large in size and have a high concentration ratio. Each module collects enough solar energy to directly heat HTF in the receiver to the desirable working temperature. Problematically, the parallel configuration increases the overall thermal loss and decreases the overall system thermal efficiency due to thermal loss at highest temperature.

Needs associated with overcoming such drawbacks exists, therefore, such as those resolved by systems and/or optimized methods of solar concentration, e.g., those including innovations related to parabolic dish approaches/arrays that increase the optical collecting efficiency while reducing the thermal loss from an array of 2-D solar modules to a heat transfer fluid.

### SUMMARY

Systems and methods are disclosed including innovations related to aspects of solar concentration and/or the collection, transfer, or utilization of thermal energy. In some exemplary implementations, systems and methods of generating thermal energy using a plurality of solar modules are set forth, with each solar module includes a collector and a receiver.

It is to be understood that both the foregoing general description and the following detailed description are exemplary and explanatory only and are not restrictive of the inventions, as described. Further features and/or variations may be provided in addition to those set forth herein. For example, the present innovations may be directed to various combinations and subcombinations of the disclosed features and/or combinations and subcombinations of several further features disclosed below in the detailed description.

### BRIEF DESCRIPTION OF THE DRAWINGS

The accompanying drawings, which constitute a part of this specification, illustrate various implementations and aspects of the present innovations and, together with the description, explain the principles of the innovations herein. In the drawings:

FIG. 1 is a block diagram illustrating a prior array of solar concentrators connected in a parallel configuration.

FIG. 2 is a block diagram illustrating an exemplary array of solar modules connected in a series configuration, according to certain aspects related to the innovations herein.

FIG. 3 is a schematic diagram illustrating an exemplary individual solar module, according to certain aspects related to the innovations herein.

FIG. 4 is a diagram illustrating an exemplary receiver, according to certain aspects related to the innovations herein.

FIG. 5 is a graph illustrating the total thermal energy loss as a function of cavity inside surface temperature for one exemplary thermal cavity receiver, according to certain aspects related to the innovations herein.

FIG. 6 is a graph illustrating the ratio of convection thermal loss versus black-body radiation loss for a cavity solar receiver with a set of specific/exemplary geometric parameters, according to certain aspects related to the innovations herein.

FIG. 7 is a graph illustrating an exemplary overall optical to thermal energy conversion efficiency as the function of heat transfer fluid temperature at the outlet of a receiver, according to certain aspects related to the innovations herein.

FIG. 8 is a graph illustrating an exemplary relationship between flow rate and solar radiation intensity in connection with maintaining output working temperature, according to certain aspects related to the innovations herein.

FIG. 9 is a graph illustrating an exemplary relationship between flow rate and working temperature of a heat transfer fluid, according to certain aspects related to the innovations herein.

FIG. 10 illustrates a block diagram of an exemplary solar collection system, according to certain aspects related to the innovations herein.

### DETAILED DESCRIPTION OF EXEMPLARY IMPLEMENTATIONS

Reference will now be made in detail to aspects of the innovations herein, examples of which are illustrated in the accompanying drawings. The implementations set forth in the following description do not represent all implementations consistent with the claimed inventions. Instead, they are merely some examples consistent with certain aspects related to the present innovations. Wherever possible, the same reference numbers will be used throughout the drawings to refer to the same or like parts.

Systems and methods are disclosed including innovations related to aspects of solar concentration and/or the collection, transfer, or utilization of thermal energy. In some exemplary implementations, systems and methods of generating thermal energy using a plurality of solar modules are set forth, with each solar module including a collector and a receiver.

For example, exemplary aspects of the innovations herein may be directed to systems and methods including transfer of solar thermal energy to a heat transfer fluid. In some exemplary implementations, a system may generate thermal energy using a plurality of solar modules, with each of the solar modules including a collector and a receiver. The collector may redirects sunlight towards the receiver thereby increasing a temperature of the receiver, and each receiver includes an input and an output, e.g., for flow of a heat transfer fluid.

In such exemplary systems, a piping system may be coupled to the inputs and outputs of the receivers. The piping system holds heat transfer fluid that absorbs thermal energy from each receiver. In one implementation, piping segments of the piping system connect receivers sequentially to incrementally increase a temperature of the heat transfer fluid to a desirable working temperature. Further, in other exemplary implementations, subgroups of serially connected receivers may be connected together in parallel connection or configurations.

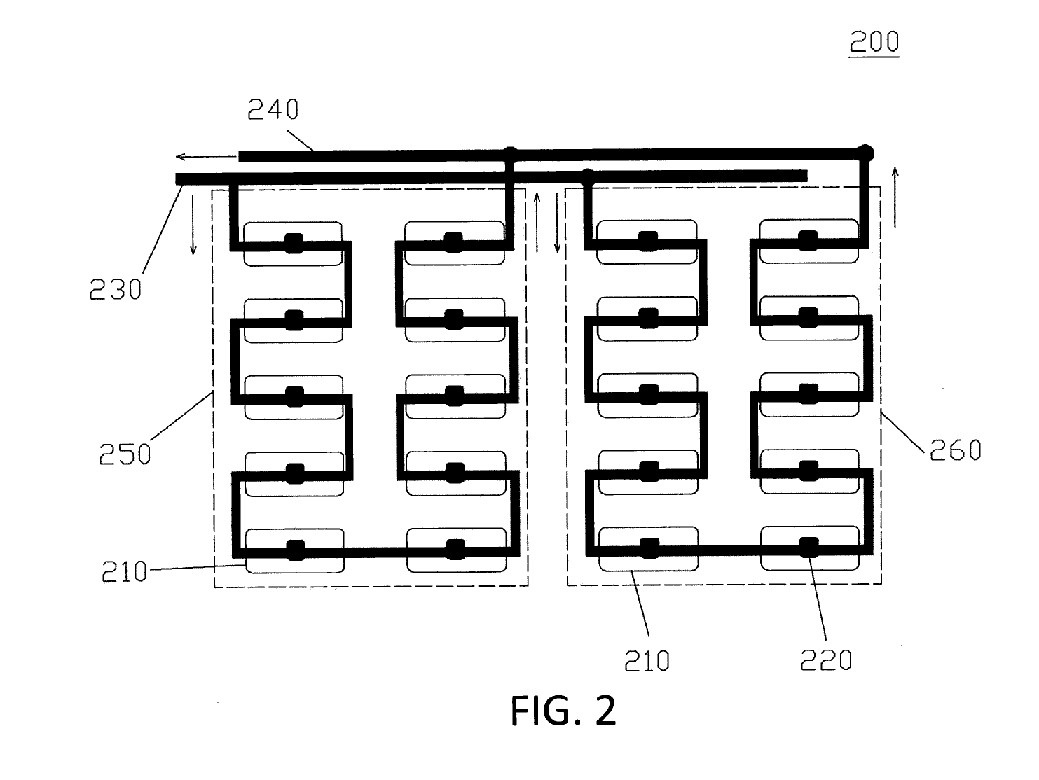

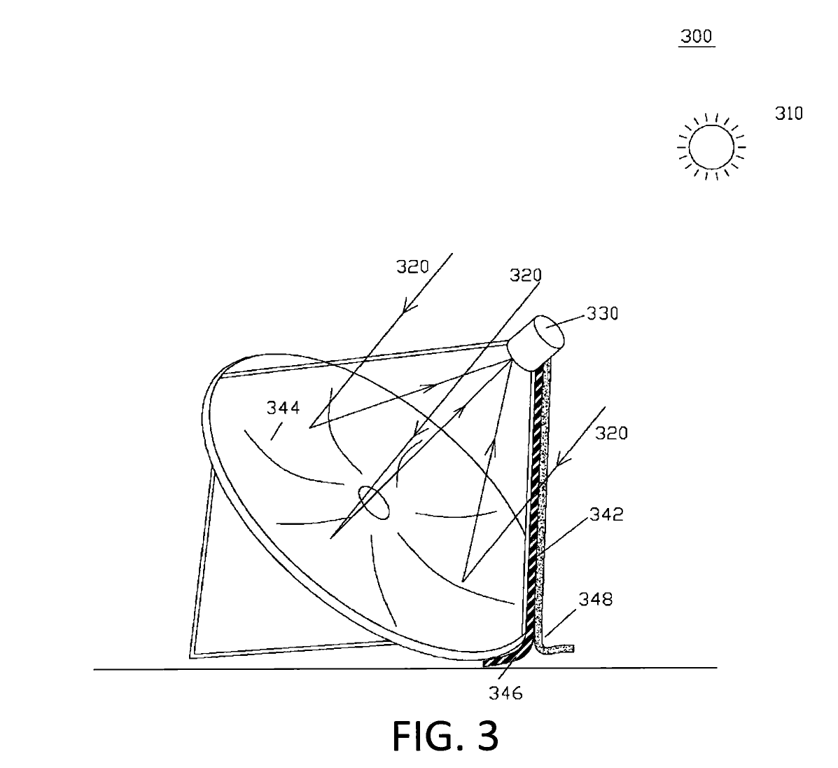

FIG. 2 is a block diagram illustrating an exemplary array of solar modules 200 connected in a series configuration, according to one exemplary implementation of the innovations herein. The array of solar modules 200 include multiple individual solar modules 210 that are arranged in rows and columns. Alternative arrangements may also be utilized consistent with the innovations herein. Each solar module 210 includes a panel (or aperture) to redirect sunlight to a receiver 220, as discussed in more detail below with respect to FIG. 3.

The exemplary array of solar modules 200 of FIG. 2 includes a first subgroup 250 and a second subgroup 260, connected by a piping system of an input pipe 230 and an output pipe 240. The input pipe 230 sends heat transfer fluid from an input reservoir to the array of solar modules 200 to absorb thermal energy from each receiver 220, causing a rise in temperature in the heat transfer fluid. The outlet pipe 240 sends the heat transfer fluid at the elevated, working temperature to an output reservoir.

Although the two subgroups 250, 260 are connected to the inlet and outlet pipes 230, 240 in a parallel manner, the solar modules 210 within each of the two subgroups 250, 260 may be connected to the inlet and outlet pipes 230, 240 in a serial manner, to reduce the impact of thermal loss on system efficiency as described in detail below. Pipe segments connect the individual solar modules 210. As such, a solar module 210 receives the heat transfer Fluid (or “HTF” herein) at an input, incrementally increases the temperature at an output, and sends the HTF to an input of a solar module 210 that is next in serial connection. The HTF continues to incrementally increase in temperature until reaching a working temperature at the outlet pipe 240. Thermal energy loss is minimized especially for those solar modules 210 whose temperature are low (i.e., lower than the working temperature). By contrast, in prior solar modules that are strictly connected in parallel, each operate at the working temperature with maximum thermal energy loss.

FIG. 3 is a schematic diagram illustrating an exemplary individual solar module 300 (e.g., a concentration solar module), according to certain implementations of the innovations herein. Note that solar module 300 is only an example, as any appropriate type of solar module can be used in the system 200 of FIG. 2 consistent with the innovations herein. In some implementations, the solar module 300 includes a collector 344 and a receiver 330. The solar collector 344 redirects incoming sunlight 320 from the Sun 310 to focus on the solar receiver 330. The HTF 342 flows into the solar receiver 330 via an inlet pipe 346, and then flows out of the solar receiver 330 via an outlet pipe 348, to convert the solar energy into thermal energy and carry the thermal energy away from the solar receiver 330.

In general, the thermal loss consists of conduction, convection and black-body radiation loss. Conduction and convection thermal losses can be limited as long as the piping and the non-aperture areas are well insulated by low thermal conduction materials. More importantly, the conduction and convection loss are proportional to the temperature difference of the thermal receiver and the ambient while the black-body radiation thermal loss is proportional to the 4^{th} power of the temperature difference, which means that at higher temperature, the black-body radiation loss is dominant.

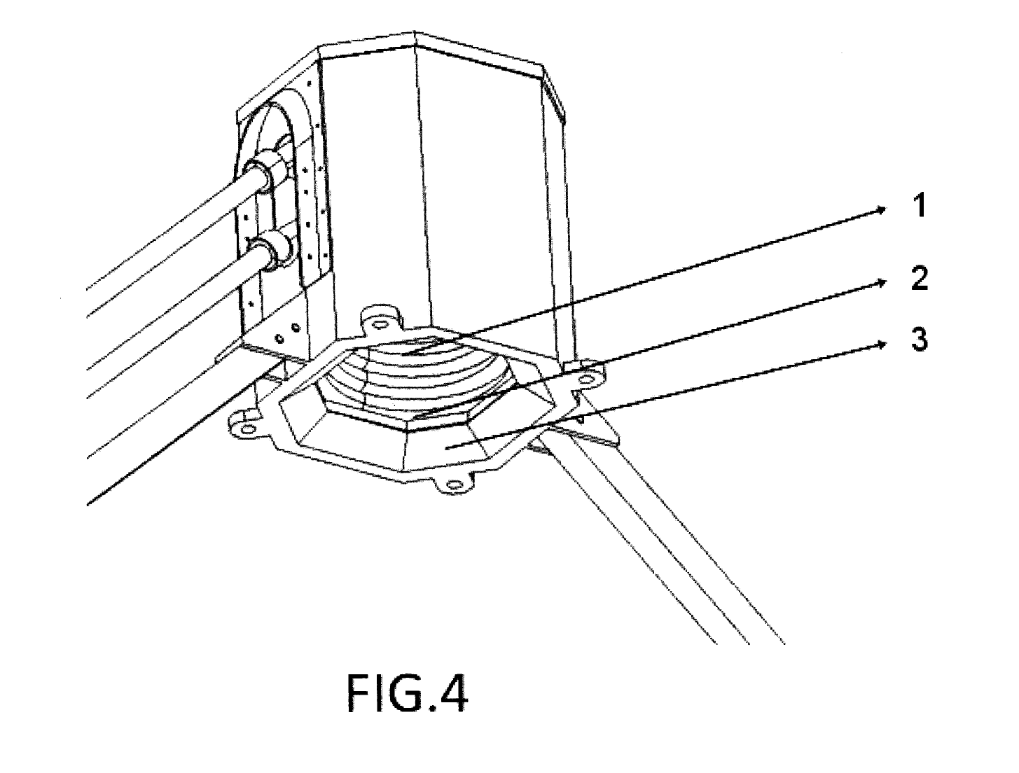

In some exemplary implementations, to greatly increase the thermal absorption efficiency and reduce the thermal energy loss for the solar receiver, a specially designed cavity like solar receiver is used, as shown in FIG. 4. By means of systems and methods consistent with such implementations, the conduction, convection and black-body radiation thermal loss for the receiver can be significantly reduced. Notably, the thermal energy loss cannot be completely eliminated because a cavity aperture is needed to take in the concentrated solar energy. (The conduction thermal loss can be easily eliminated by thermal insulation for the connecting input and output tubes). The thermal energy loss of such a cavity solar receiver can be described with following equation:

Qₗₒₛₛ_{_{—}}_{SC}=h_{conv}A_{cav}(T_{cav}−Tₐ)+σ_{B}ε_{cav}F_{cav,a}A_{cav,a}(T_{cav}⁴−T_{S}⁴) (1)

where the subscript “cav” refers to the cavity of the solar receiver and “cav,a” refers to the aperture of the cavity of the solar receiver.
ε_{cav}=emittance of receiver tube
T_{cav}=surface temperature of receiver tube (K)
Tₐ=ambient temperature (K)
T_{S}=sky temperature (K) (typically assumed to be 6 Kelvins lower than ambient temperature)
A_{cav}=surface area of receiver tube (m²)
A_{cav,a}=aperture area of receiver cavity (m²)
σ_{B}=Stefan-Boltzmann constant (5.6696×10⁻⁸ W/m² K²)
F_{cav,a}=shape factor
h_{conv}=convective heat-transfer coefficient at the inside surface of cavity solar receiver (W/m²° C.)

The convective heat-transfer coefficient has some dependence on the cavity surface temperature. In some exemplary implementations, for example, this coefficient may be calculated according to thermal dynamic theory for a set of given geometric parameters for the cavity. All the other coefficients in formula (1) are either universal constants or can be determined easily according to the specific cavity structure, parameters, and/or geometry.

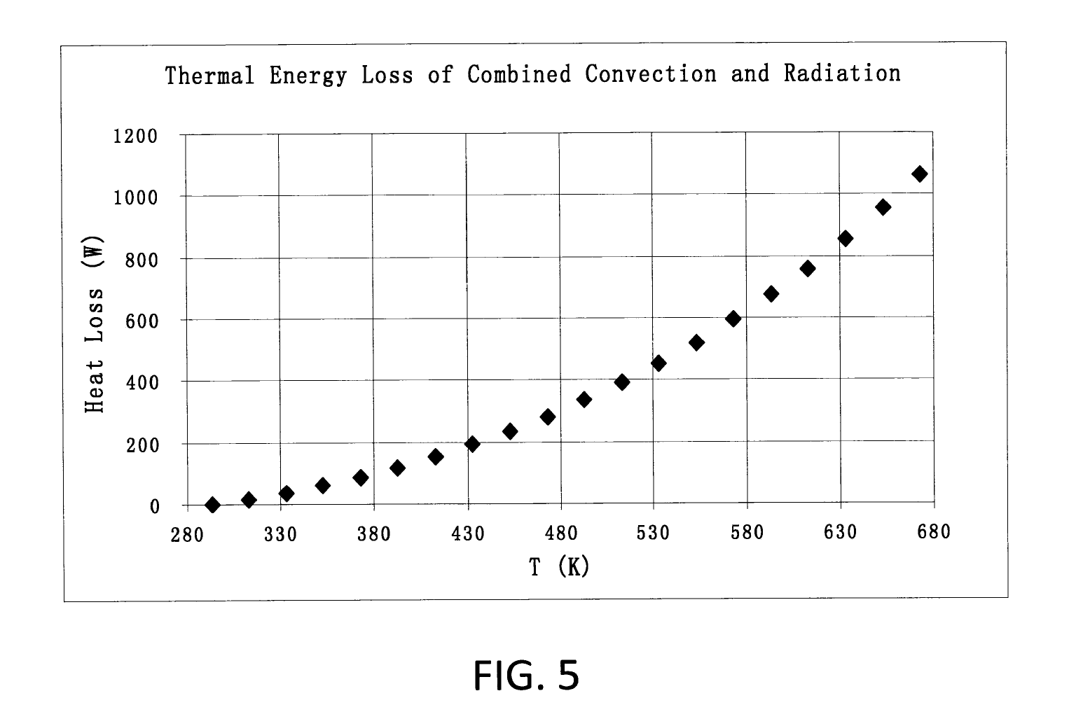

FIG. 5 is a graph illustrating an exemplary total thermal energy loss as a function of cavity inside surface temperature for a specific thermal cavity receiver, according to certain aspects related to the innovations herein. It should be noted that this thermal energy loss value only depends on the cavity receiver's surface temperature, but independents of the solar energy focused into the cavity. The solar energy collected that focused into the cavity depends on the optical collection efficiency, per the discussion above. More specifically, this optical collection efficiency is determined by geometric characteristic of the optics for the solar collector (mainly defined by cosine angle loss) and the reflection mirror's reflectivity (often silver coated mirrors with reflectivity of 85 to 95%). This optical collection efficient η₀ can normally achieve better than 80% for parabolic dish solar collectors. In this case, the overall optical to thermal energy conversion efficiency may be realized via the following for any individual solar module

η=Pₒᵤₜ/Pᵢₙ=(η₀Pᵢₙ−P_{L})/Pᵢₙ (2)

Where Pᵢₙ=E_{S,DN}×Aᵣ, P_{L} as defined in formula (1); E_{S,DN} is the direct normal solar radiation intensity and Aᵣ is the effective optical collecting area for the solar collector. Pₒᵤₜ is the output thermal energy from the solar thermal receiver, which can be expressed by the following equation:

Pₒᵤₜ=dQ/dt=(dm/dt)CₚΔT=(dV/dt)ρCₚΔT (3)

Where dV/dt is the flow rate for the HTF, V is the volume of the HTF, ρ is the density of the HTF, Cₚ is the specific heat capacity of the HTF, and ΔT is the HTF temperature difference between the inlet and outlet of the solar receiver.

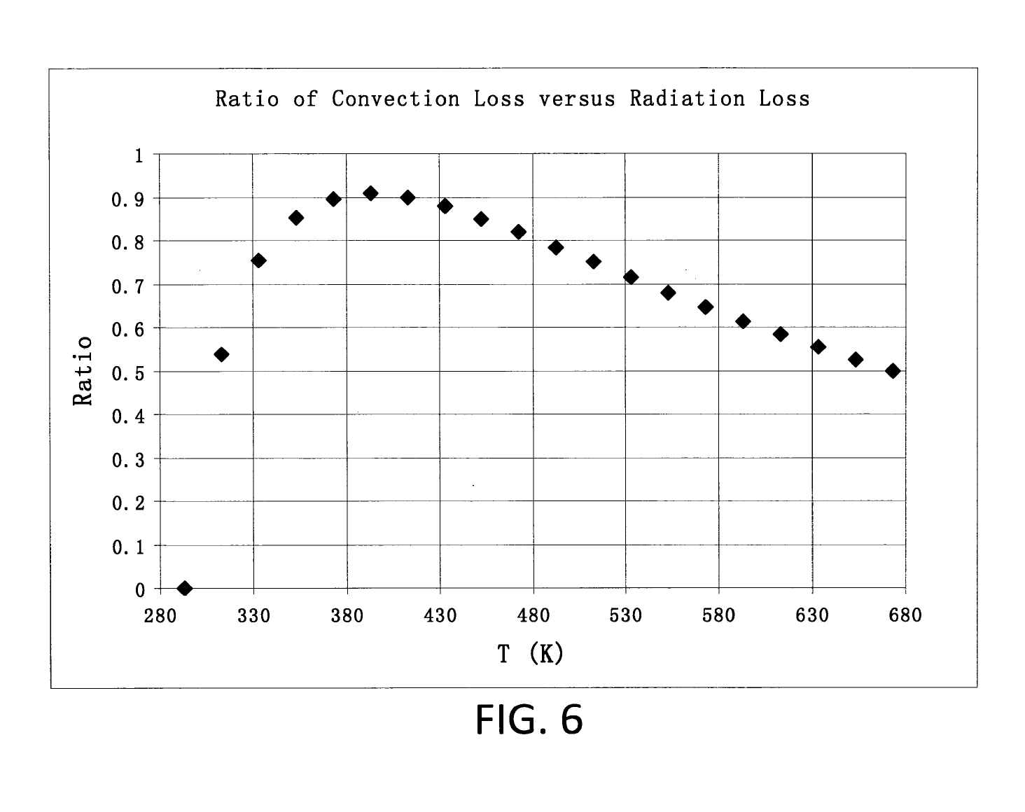

FIG. 6 is a graph illustrating the ratio of convection thermal loss versus black-body radiation loss for a cavity solar receiver with a set of specific/exemplary geometric parameters, according to certain aspects related to the innovations herein. In such implementations, the black-body radiation thermal loss contributes the major part for the total thermal loss at the temperature range of higher than 413K (or >140° C.).

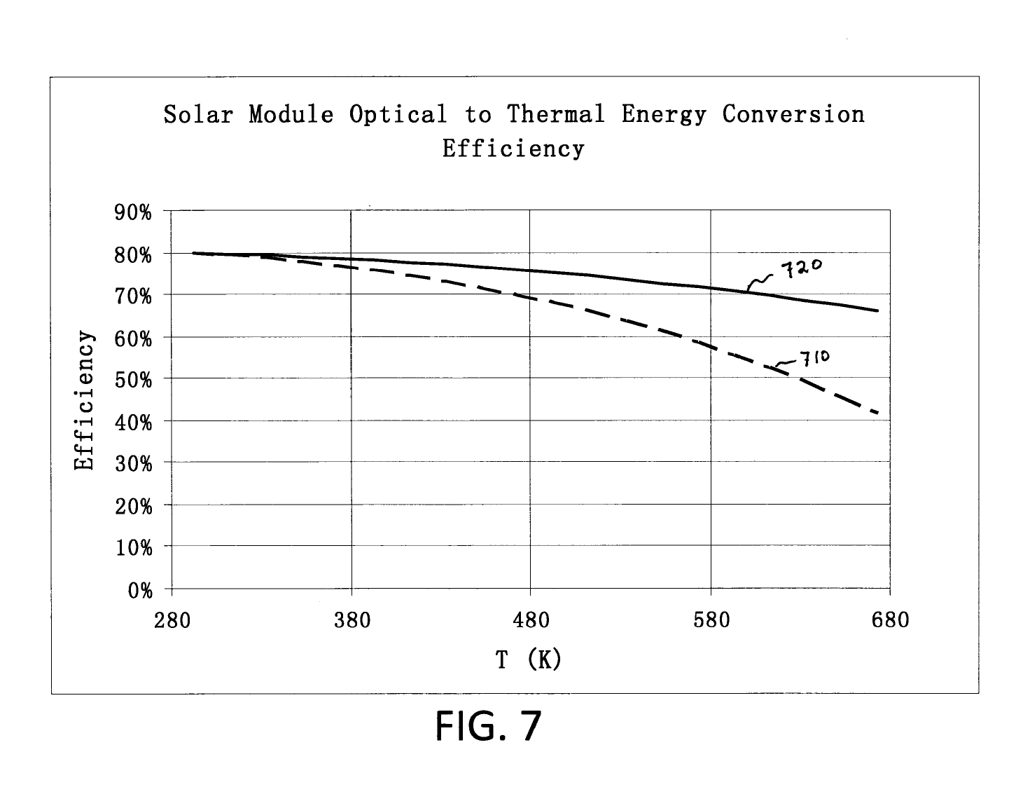

FIG. 7 is a graph illustrating an exemplary overall optical to thermal energy conversion efficiency as the function of heat transfer fluid temperature at the outlet of the receiver, corresponding to the thermal loss described in FIG. 5, according to certain aspects related to the innovations herein. The optical collection efficiency η₀ for this solar module is 80%. According to FIG. 7, the optical to thermal conversion efficiency for individual solar module 710 is significantly lower than the integrated efficiency from multiple modules in serial connections 720, especially when the output temperature reaches 430K and above (>200° C.). Consistent therewith, innovative aspects of using the presently described systems and methods having serial connection features/configurations for the 2-D tracking solar modules are demonstrated versus conventional parallel connection configurations.

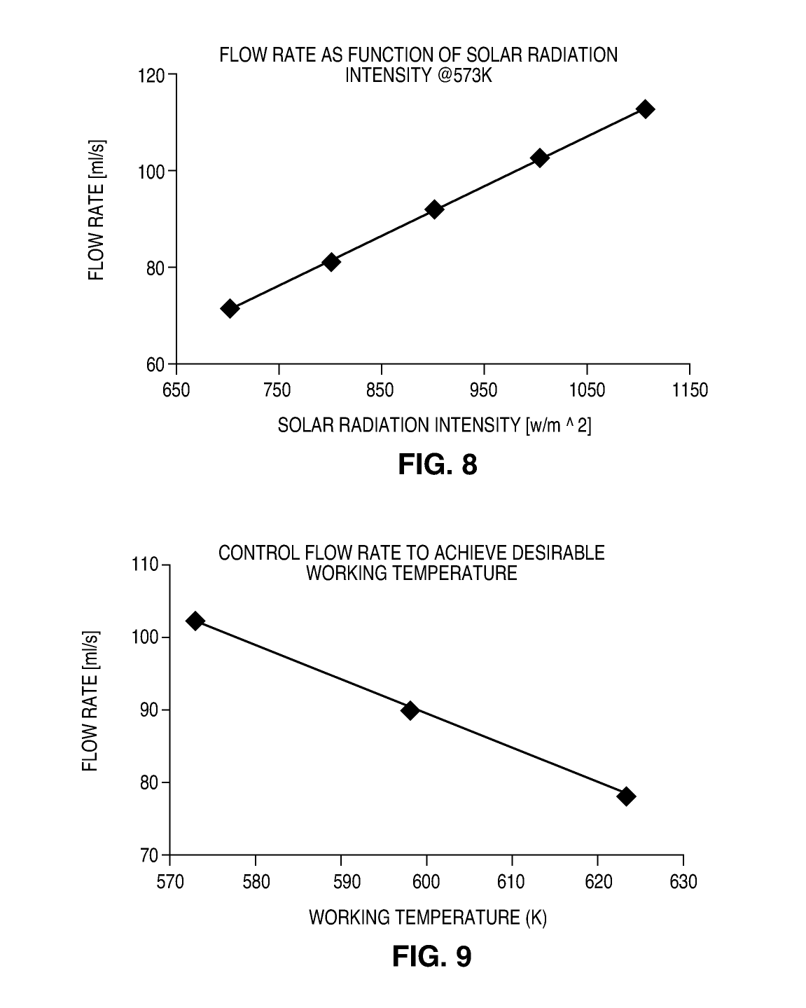

In further exemplary implementations, as an amount of collected thermal energy varies, a flow rate of the heat transfer fluid may be automatically varied by a computer control module to maintain the working temperature. For example, at noon, more energy may be collected than at sunrise due to higher solar radiation intensity, however, the final working temperature remains constant. FIG. 8 illustrates one of such exemplary relationship between the flow rate as function of solar radiation intensity in order to maintain the output working temperature at 573K (300° C.). In this example, 30 solar modules are connected in serial while each solar module has optical collection efficiency of 85% with effective optical collecting area of 2.76 m².

In other exemplary implementations, the flow rate may be controlled so that a desirable working temperature can be obtained. FIG. 9 is a graph illustrating an exemplary relationship between flow rate and working temperature of a heat transfer fluid, according to certain aspects related to the innovations herein. As shown in FIG. 9, for example, the working temperature fluctuates as a function of flow rate, and systems and methods herein may include flow rate adjustment features to achieve desirable working temperature.

In further exemplary implementations, referring back to FIG. 2, a pressure drop between the inlet pipe 230 and the outlet pipe 240 is constant between the two subgroups 250, 260.

The collector collects solar energy from sunlight and focuses it to the receiver 220. Each thermal receiver has an inlet pipe and an outlet pipe allowing heat transfer fluid in to flow through the receiver 220. A temperature of the heat transfer fluid increases at the outlet pipe relative to the inlet pipe.

In accordance with such systems, various improved methods of generating thermal energy are set forth herein. In one exemplary implementation, a method of generating thermal energy may comprise operating a sequential series of solar thermal 2-dimensional focusing concentrators at a working temperature desired; obtaining a measure of collected thermal energy; and automatically adjusting a flow rate of the heat transfer fluid as a function of the measure of collected thermal energy; wherein the flow rate of the heat transfer fluid is automatically adjusted to maintain the working temperature.

In another implementation, a coiled cavity 1, 2, 3 may be used, as illustrated in FIG. 4. According to formula (1), the thermal loss is a function of difference between inner cavity surface and ambient temperatures. To improve the optical to thermal energy conversion efficiency, the Renault number of the heat transfer may be enlarged as much as possible because the heat transfer rate between cavity inner surface and the heat transfer fluid is proportional to the 0.8^{th} power of the Renault number of the heat transfer fluid as described in the following equations:

$$\begin{matrix}{h}_{pipe} = Nu \frac{λ}{d} & ( 4 ) \\ Nu = 0.023 {Re}^{0.8} {Pr}^{n} & ( 5 )\end{matrix}$$

Where Re is a Reynolds number,

$$Re = \frac{ρ Ud}{μ} \qquad ( 6 )$$

And Pr is a Prantdl number,

$$Pr = \frac{v}{α} \qquad ( 7 )$$

v=Coefficient of heat conductivity, [m²/s]

μ=Coefficient of heat conductivity, [mPa sec]

α=Coefficient of heat diffusivity, [m²/s]

λ=Coefficient of heat conductivity, [W/m K]

ρ=Density of fluid, [kg/m³]

d=Diameter of pipe, [m]

R=Radius of spiral pipe, [m]

U=Fluid Velocity, [m/s]

n=0.4 for heating of the fluid

In this way, the temperature difference between the cavity inner surface and the HTF at the outlet of the cavity can be minimized. In order to increase the Renault number of HTF, the flow rate should be as large as possible. However, the flow rate in the coiled tube is limited due to pressure drop in the tube as described in the following formula:

ΔP=2ρ³U²λL/d (8)

which indicates that the pressure drop in the flow tube is proportional to the square of the flow speed.

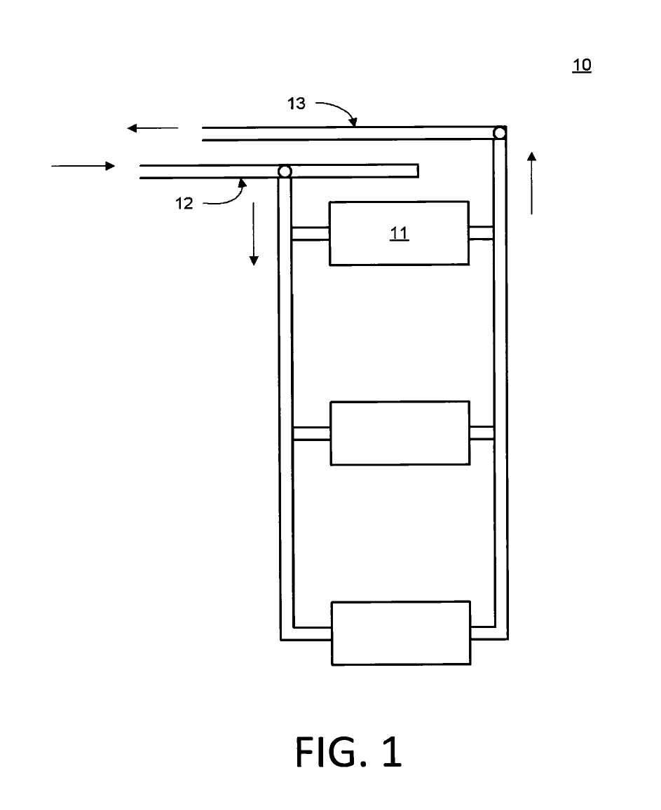

According to equation (3), for a given thermal energy input (constant solar radiation intensity), increasing the flow rate of the heat transfer fluid will reduce the incremental increase in temperature (ΔT). In addition, due to smaller ΔT for each individual solar module, multiple solar modules can be serially connected to reach the desirable working temperature only at the end module of the serial chain. Since not all the solar module receivers now work at the working temperature, the average overall thermal loss is reduced, the total thermal output is increased, and overall optical to thermal energy conversion efficiency is increased, as illustrated in the solid curve 602 in FIG. 7. Thus, the average efficiency of serially connected solar modules is much higher than the configurations where each of the single solar modules working at the highest working temperature, as indicated in FIG. 1, where prior art is illustrated.

Typically, the number of modules connected in series can range from 10 to 100 units with a practical diameter of the piping at practical pumping speed. A solar field with a large number of solar modules that exceeds the number of in serial connection should be connected in parallel to further increase the flow rate and therefore the thermal output power, as illustrated in FIG. 2.

Significantly, the solid curve 720 in FIG. 7 illustrated a much improved system optical to thermal conversion efficiency. This system level optical to thermal conversion efficiency is much higher than a centralized receiver or parallel connected receivers at a given temperature. 2-D modular heliostat arrays consistent with the innovations herein are designed to be connected in series in a row and multiple rows are then collected in parallel to increase the fluid flux. At given concentration ration (100 as show in FIG. 7) given that the optical collecting efficiency of 80%, the average system receiver thermal efficiency (at DNI of 1000 W/m²) reaches 71.6% (at HTF temperature 300° C.) and 69% (at HTF temperature 350° C.).

Exemplary thermal energy generation methods herein may involve various features set forth in this disclosure. For example, an exemplary method of processing thermal energy may comprise operating a sequential series of solar thermal 2-dimensional focusing concentrators at a working temperature desired, obtaining a measure of collected thermal energy, and automatically adjusting a flow rate of heat transfer fluid (HTF) as a function of the measure of collected thermal energy, wherein the flow rate of the HTF is automatically adjusted to maintain the working temperature. Another exemplary method may comprise operating a sequential series of solar thermal 2-dimensional focusing concentrators at a specified temperature provided via working temperature of HTF within the concentrator, obtaining a measure of collected thermal energy, calculating incremental change in temperature data regarding change in temperature to the working temperature given by one or more of the concentrators, and determining an optimized arrangement of the concentrators in an array, including an optimal quantity of sequential/serial concentrators, as a function of the incremental change in temperature data. The measure of thermal energy being collected may be the solar radiation intensity, as set forth in FIG. 8 and the associated description thereof. Additionally, such methods may further comprise performing a fitting process as a function of experimental data to optimize quantity and/or operating parameters of the focusing concentrators. In some implementations, the fitting function may be further performed as a function of a Renault number of the HTF and/or a change (delta) in the Renault number. Further, the quantity of concentrators and/or operating parameters of the focusing concentrators may also be optimized to reduce blackbody radiation loss/losses.

As a result of one or more of the features set forth above, thermal energy loss may be reduced in the innovative systems and methods herein, thereby increasing collection efficiency from an array of solar modules.

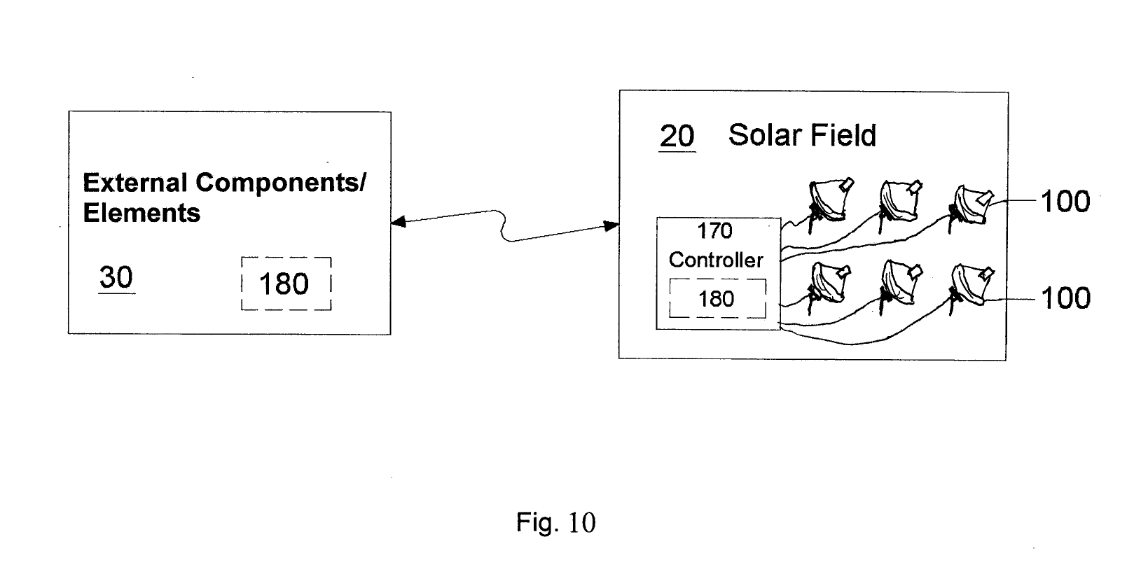

In general, exemplary systems may comprise one or more solar modules and/or solar receivers as set forth herein, one or more control elements associated with controlling parameters and/or operation of the one or more solar modules and/or solar receivers; and a computing component configured to process information and/or instructions associated with the one or more solar modules, solar receivers, and/or control elements. FIG. 10 illustrates a block diagram of an exemplary solar collection system 10 in accordance with one or more implementations of the innovations herein. Referring to FIG. 10, the solar collection system 10 may comprise a solar field 20 including solar collectors 100 and a controller 170 and, optionally, one or more elements of external systems 30. The controller 170 may include one or more computing components, systems and/or environments 180 that perform, facilitate or coordinate control of the collectors. As explained in more detail below, such computing elements may take the form of one or more local computing structures that embody and perform a full implementation of the features and functionality herein or these elements may be distributed with one or more controller(s) 170 serving to coordinate the distributed processing functionality. Further, the controller 170 is not necessarily in close physical proximity to the collectors 100, though is shown in the drawings as being associated with solar field 20. Solar collection system 10 may also include one or more optional external devices or systems 30, which may embody the relevant computing components, systems and/or environments 180 or may simply contain elements of the computing environment that work together with other computing components in distributed arrangements to realize the functionality, methods and/or innovations herein.

With regard to computing components and software embodying one or more aspects of the innovations herein, such as those related to operation/configuration and/or collector/collection features, the innovations herein may be implemented consistent with numerous general purpose or special purpose computing system environments or configurations. Various exemplary computing systems, environments, and/or configurations that may be suitable for use with the innovations herein may include, but are not limited to, personal computers, servers or server computing devices such as routing/connectivity components, hand-held or laptop devices, multiprocessor systems, microprocessor-based systems, set top boxes, smart phones, consumer electronic devices, network PCs, other existing computer platforms, distributed computing environments that include one or more of the above systems or devices, etc.

Aspects of the innovations herein may be described in the general context of computer-executable instructions, such as program modules, being executed by a computer, computing component, etc. In general, program modules may include routines, programs, objects, components, data structures, etc. that perform particular tasks or implement particular abstract data types. The innovations herein may also be implemented in/via distributed computing environments where tasks are performed by remote processing devices (e.g., 30, 180) that are linked through a communications network. In a distributed computing environment, program modules may be located in both local and remote computer storage media including memory storage devices.

Computing component 180 may also include one or more type of computer readable media. Computer readable media can be, for example, any available media that is resident on, associable with, or can be accessed by computing component 180. In one exemplary implementation, such computer readable media may contain or be configured to execute computer-readable instructions related to solar concentration, with the computer-readable instructions comprising instructions for processing information, processing instructions, and/or performing actions consistent with one or more steps or features set forth herein. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component 180. Communication media may comprise computer readable instructions, data structures, program modules or other data embodying the functionality herein. Further, communication media may include wired media such as a wired network or direct-wired connection, and wireless media such as acoustic, RF, infrared and other wireless media. Combinations of the any of the above are also included within the scope of computer readable media.

In the present description, the terms component, module, device, etc. may refer to any type of logical or functional process or blocks that may be implemented in a variety of ways. For example, the functions of various blocks can be combined with one another into any other number of modules. Each module can be implemented as a software program stored on a tangible memory (e.g., random access memory, read only memory, CD-ROM memory, hard disk drive) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, implementations and features of the present innovations may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe components such as software, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various processes and operations according to the innovations herein or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the inventions, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain exemplary implementations of the present innovations have been specifically described herein, it will be apparent to those skilled in the art to which these innovations pertain that variations and modifications of the various implementations shown and described herein may be made without departing from the spirit and scope of the innovations herein. Accordingly, it is intended that the inventions be limited only to the extent required by the appended claims and the applicable rules of law.

1. A method of generating thermal energy, the method comprising:
operating a sequential series of solar thermal 2-dimensional focusing concentrators at a working temperature desired;
obtaining a measure of collected thermal energy; and
automatically adjusting a flow rate of heat transfer fluid (HTF) as a function of the measure of collected thermal energy;
wherein the flow rate of the HTF is automatically adjusted to maintain the working temperature.

2. The method of claim 1 further comprising performing a fitting process as a function of experimental data to optimize quantity and/or operating parameters of the focusing concentrators.

3. The method of claim 2 wherein the fitting function is further performed as a function of a Renault number of the HTF.

4. The method of claim 3 wherein the fitting function is performed as a function of a delta/change in the Renault number.

5. The method of claim 1 wherein quantity and/or operating parameters of the focusing concentrators are optimized to reduce blackbody radiation loss(es).

6. A method of generating thermal energy, the method comprising:
operating a sequential series of solar thermal 2-dimensional focusing concentrators at a specified temperature provided via working temperature of HTF within the concentrator;
obtaining a measure of collected thermal energy;
calculating incremental change in temperature data regarding change in temperature to the working temperature given by one or more of the concentrators; and
determining an optimized arrangement of the concentrators in an array, including an optimal quantity of sequential/serial concentrators, as a function of the incremental change in temperature data.

7. The method of claim 6 further comprising performing a fitting process as a function of experimental data to optimize quantity and/or operating parameters of the focusing concentrators.

8. The method of claim 7 wherein the fitting function is further performed as a function of a Renault number of the HTF.

9. The method of claim 8 wherein the fitting function is performed as a function of a delta/change in the Renault number.

10. The method of claim 6 wherein quantity and/or operating parameters of the focusing concentrators are optimized to reduce blackbody radiation loss(es).

11-37. (canceled)

38. A system comprising:
one or more solar modules and/or solar receivers;
one or more control elements associated with controlling parameters and/or operation of the one or more solar modules and/or solar receivers; and
a computing component configured to process information and/or instructions associated with the one or more solar modules, solar receivers, and/or control elements.

39. At least one computer readable medium containing or configured to execute computer-readable instructions for solar concentration, the computer-readable instructions comprising instructions for:
processing information and/or instructions, and/or performing actions consistent with one or more steps or features set forth herein.
